(19) United States
(12) Patent Application Publication
(10) Pub. No.: US 2001/0027445 A1
(43) Pub. Date: Oct. 4, 2001

(54) System and method for realizing transactions supported by a directory access protocol

(75) Inventors: Markus Eichelsdoerfer, Rothenberg/Finkenbach (DE); Sven Lange-Last, Leinfelden-Echterdingen (DE)

Correspondence Address: William A. Kinnaman, Jr., IBM Corporation-MS P386, 2455 South Road, Poughkeepsie, NY, 12601, US

(73) Assignee: International Business Machines Corporation, Armonk, NY (US)

(21) Appl. No.: 09/814,364

(22) Filed: Mar. 21, 2001

(30) Foreign Application Priority Data
Mar. 30, 2000 (DE) 00106869.1

(51) Int. Cl. G06F 17/60

(52) U.S. Cl. 705/65

(57) ABSTRACT

A system and method for realizing transactions within an existing protocol for accessing information uses control information supported by the protocol for specifying transactional or non-transactional requests. This is achieved by adding controls, e.g. a transaction control and a transaction identifier (ID), to individual requests. The transaction control may be a control for opening or closing a transaction. The transaction ID identifies each individual request belonging to certain transaction. A transaction is opened by a client program by adding a transaction control with a value indicating a new transaction to the first request. Preferably, the server program generates a transaction ID for the opened transaction and sends back a return code containing the transaction ID. All subsequent requests belonging to that transaction are extended with the transaction ID by the client program. The transaction is closed by adding a transaction control with value indicating a commit or a rollback to the individual request. The inventive method and system are preferably used within LDAP using V3 controls.

### BACKGROUND OF THE INVENTION

1. Field of the Invention

The present invention relates to a system and method for realizing transactions by using controls of a protocol. More specifically, the present invention relates to a system and method to secure consistency of related entries in a directory information tree (DIT) when entries are updated or extended by using a directory access protocol, especially LDAP (Lightweight Directory Access Protocol) V3.

2. Description of the Related Art

In information technology, protocols define a set of rules that regulate the way data is transmitted between computers. LDAP V3 is a protocol designed for accessing information stored in a DIT (directory information tree). LDAP V3 is a proposed Internet standard and is disclosed in IETF RFC 2251. LDAP V3 enables LDAP clients to send requests for searching and/or updating entries in the DIT to an LDAP server. The LDAP server performs the client's request and sends back a response containing a return code.

LDAP V3 only allows atomic requests. An individual request belonging to a sequence of requests is performed independently of the others. In particular, if one request of the sequence fails, the LDAP server does not roll back the effects of the requests that were already successfully performed.

LDAP V3 allows so-called controls: LDAP requests can be extended with additional information, i.e. a control name and a control value. The control name is a unique LDAP object identifier (OID). The LDAP server has to decide how to handle a request containing controls.

The LDAP client can specify that the LDAP server must recognize a control (control is critical) or is requested to recognize a control (noncritical). Also the LDAP server can add controls to the responses it sends to LDAP clients.

Assume that two entries A and B in the DIT are strongly related in the sense that entry B must be updated whenever entry A is updated. If an LDAP client sends two subsequent update requests R_{A} (on entry A) and R_{B} (on entry B) to the LDAP server and R_{A} succeeds and R_{B} fails, the effects of R_{A} have to be rolled back to keep the DIT consistent.

The typical solution for this problem known in computer technology is so called transactions: A whole sequence of requests is performed as if it were a single atomic request. Either the whole sequence of requests is performed successfully or none of the requests are performed. A transaction can be opened explicitly, closed explicitly (commit), or caused to fail explicitly (rollback).

LDAP V3 does not contain the transaction concept. So far, LDAP clients cannot run transactions against an LDAP server since LDAP V3 does not contain syntactical means to work with transactions.

Patent abstract of Japan JP 11096062 discloses a directory access method for securing consistency in directory information. The method is based on a directory server and a client which are connected by a network. A database for storing and managing directory information is connected to the directory server. The directory server has a non-transaction-processing part for processing respective access requests as different actions. A transaction-processing part processes a series of access requests as a single transaction. A phase managing table stores a processing phase for each connection with the client. Based on the stored processing phase, a phase managing part delivers the accepted access request to the non-transaction part or to the transaction-processing part. The disclosure does not teach how the inventive directory access method may be used within an existing protocol without adapting the protocol itself.

### SUMMARY OF THE INVENTION

It is therefore an object of the present invention to provide a system and method for realizing transactions by using rules specified in a protocol.

Furthermore, it is an object of the present invention to provide a set of rules accomplishing an easy method to work with transactions within a certain protocol without extending the protocol itself.

Furthermore, it is an object of the present invention to provide a system and method for realizing transactions by using rules specified in the LDAP V3 protocol.

Finally, it is an object of the present invention to provide a system and method for securing consistence of related directory information by using rules specified in a protocol.

These objects are solved by the features of the independent claims. Preferred embodiments of the present invention are set forth in the subclaims.

The present invention contemplates a system and method for realizing transactions within an existing protocol used for accessing information. The present invention uses controls supported by the protocol for specifying transactional or non-transactional requests. This is achieved by adding controls, e.g. a transaction control and a transaction identifier (ID), to individual requests. The transaction control may be a control for opening or closing a transaction. The transaction ID identifies each individual request belonging to a certain transaction. A transaction is opened by a client program by adding a transaction control with a value indicating a new transaction to the first request. Preferably, the server program generates a transaction ID for the opened transaction and sends back a return code containing a transaction ID. All subsequent requests belonging to that transaction are extended with the transaction ID by the client program. The transaction is closed by adding a transaction control with a value indicating a commit or a rollback to the individual request, preferably to the last request. In a preferred embodiment of the present invention, if the client wants to commit an open transaction directly after having performed a request, the request is extended with a transaction control having a value indicating a commit. If the client wants to roll back an open transaction without having performed the request, the request is extended with a transaction control having a value indicating a rollback. The inventive method and system are preferably used within LDAP using V3 controls.

### BRIEF DESCRIPTION OF THE DRAWINGS

The present invention is described in detail using a preferred embodiment with figures, where:

FIG. 1A shows a preferred embodiment of a client-server architecture in which the present invention may be used.

FIG. 1B shows another embodiment of a client-server architecture in which the present invention may be used.

FIGS. 1C-1D show a structure of a directory information tree used by the LDAP protocol.

FIGS. 2A-2B show basic methods for realizing transaction based on LDAP according to the present invention.

FIGS. 3A-3M show different response behavior of the LDAP server based on the information contained in the requests.

### DESCRIPTION OF THE PREFERRED EMBODIMENTS

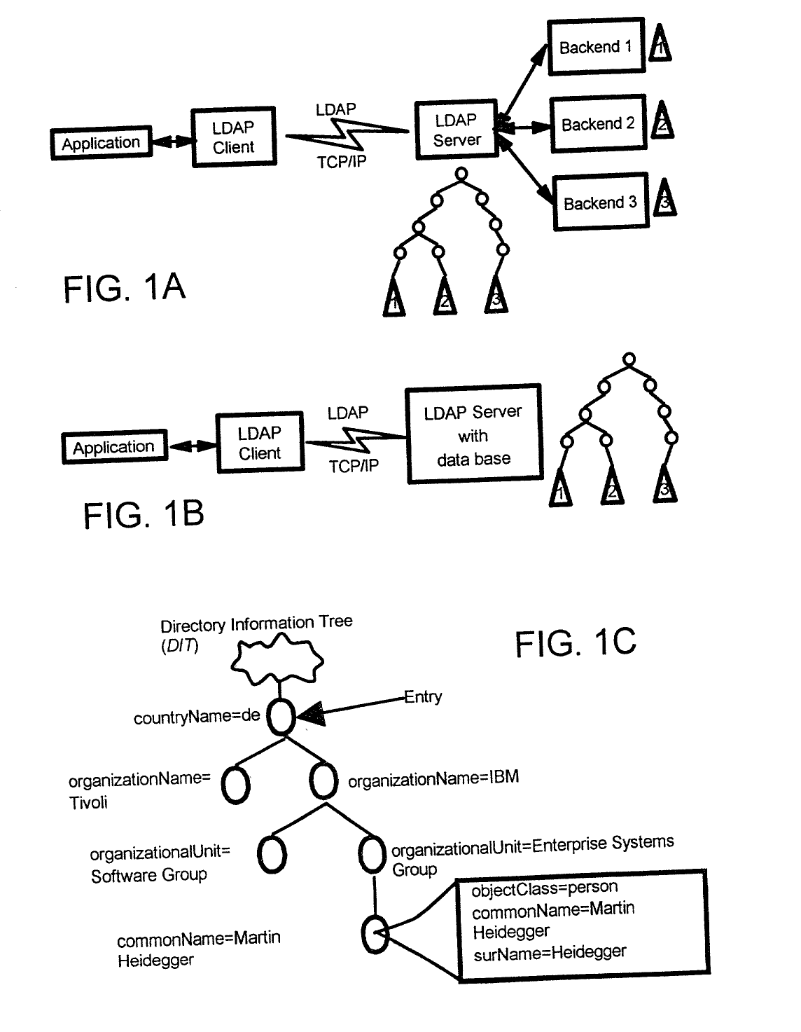

FIG. 1A shows a typical client-server architecture used by the present invention. On the client system, an application and an LDAP client program are installed. The application communicates with the LDAP client, e.g. generates and sends update requests (add, modify, delete a entry in a DIT) to the LDAP client program. The LDAP client program communicates with an LDAP server program via a network.

The LDAP client and the LDAP server use, for example, the LDAP protocol based on TCP/IP. The LDAP client program adds a transaction control to a request for opening a transaction as taught by the present invention and sends that request to the LDAP server program. The LDAP server program generates a transaction ID and sends back a return code to the LDAP client program containing that transaction ID. The LDAP client program extracts the transaction ID from the return code and adds the transaction ID to each individual request belonging to that transaction. In a preferred embodiment, the LDAP server program delegates the management of the DIT to backends. Each backend 1, 2, 3 owns a specified DIT portion 1, 2, 3.

FIG. 1B shows another embodiment of a client-server architecture used by the present invention. In FIG. 1B LDAP Server manages the DIT itself. Requests may be performed by buffering or journaling. With buffering, the LDAP client program sends a request extended by a transaction control to the LDAP server program. The LDAP server program opens a new transaction by generating a queue in which all requests belonging to the transaction are stored. If the queuing is successful, the LDAP server immediately generates a response which is sent to the LDAP client program. With journaling, the LDAP client program sends a request extended by transaction control to the LDAP server program. The LDAP server program opens a new transaction, generates a transaction ID and immediately executes the request. The status of data of the directory information tree before executing the request is stored on a nonvolatile storage medium.

FIG. 1C shows a directory information tree (DIT) as used by LDAP. The DIT consists of entries, e.g. countryName, organizationName, organizationUnit, commonName. Each entry has an object class (e.g. person). The object class determines attributes. Attributes have values of a certain type.

FIG. 1D shows the structure of an address of an entry in a DIT. The address is a distinguished name (DN). The address of an entry concatenates all relative distinguished names (RDNs) on the path from the entry to the root. The DN suffix denotes a subtree.

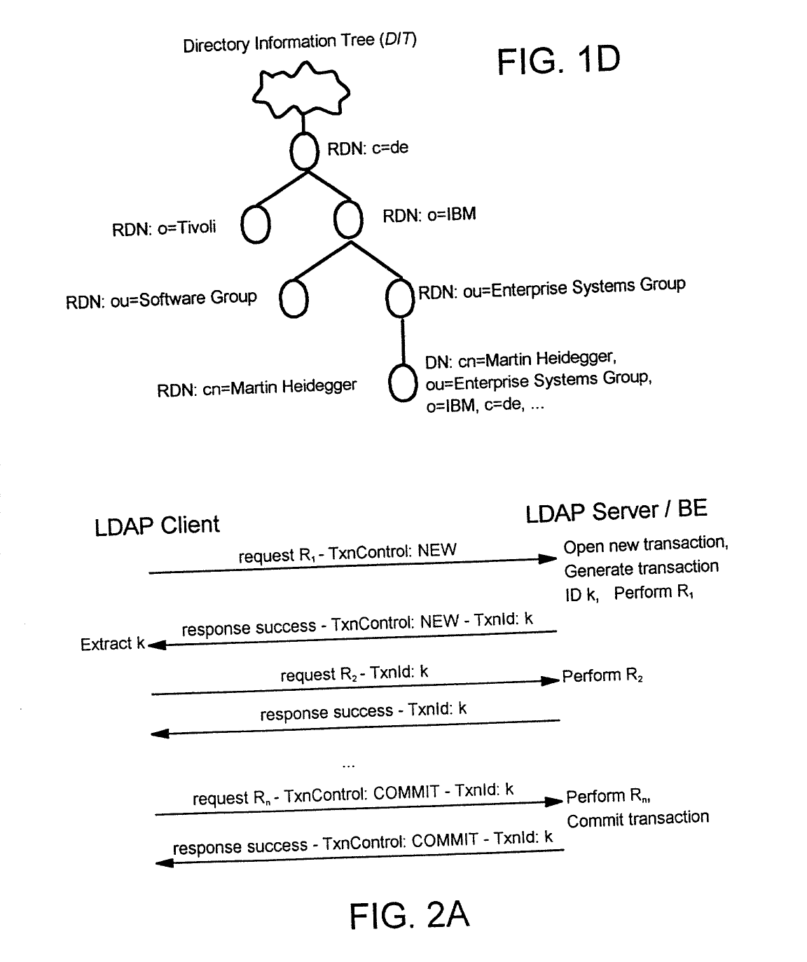

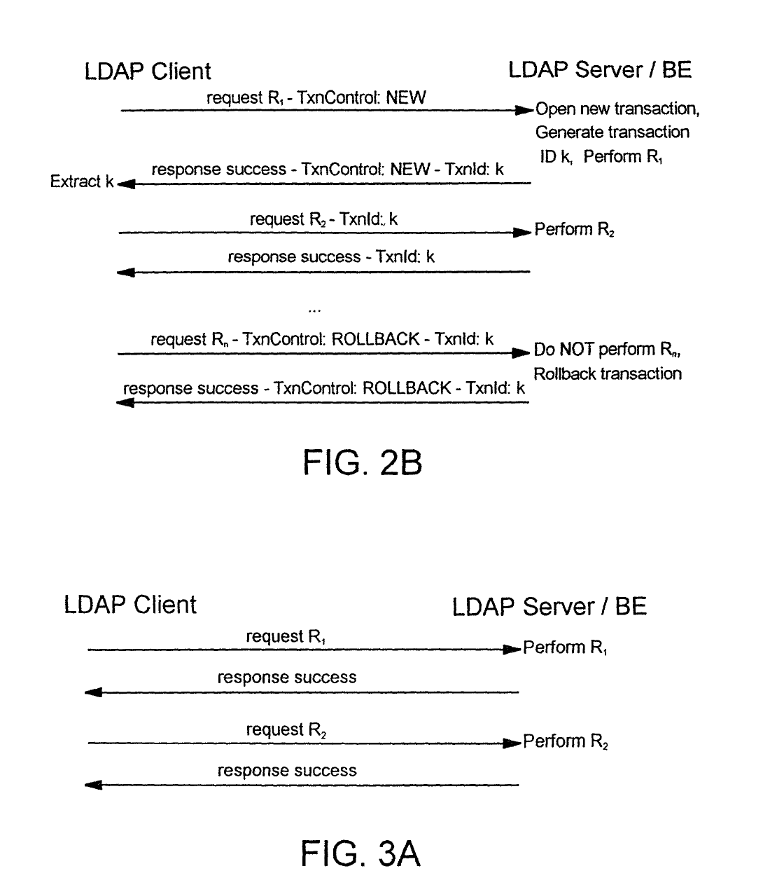

FIG. 2A shows the basic method for realizing transactions supported by LDAP according to the present invention. In order to perform a transaction containing a sequence of LDAP update requests R₁ R₂ . . . Rₙ, an LDAP client adds a transaction control (TxnControl) with the value NEW to request R₁ to open a new transaction; the transaction ID (TxnId) is not specified. All subsequent requests R₂ . . . Rₙ are extended with the transaction ID (TxnId) k that is generated by the LDAP server. The value of the transaction ID k must be a valid ID for an open transaction. The LDAP server sends a response containing such an ID k when opening a new transaction (see below). If an LDAP client wants to commit an open transaction directly after having performed Rₙ, it extends Rₙ with a transaction control (TxnControl) having the value COMMIT. The transaction ID is also specified with an appropriate value k.

FIG. 2B shows the same transaction method as shown in FIG. 2A, however with a transaction control (TxnControl) of ROLLBACK. If an LDAP client wants to roll back an open transaction without having performed Rₙ, it extends Rₙ with a transaction control (TxnControl) having the value ROLLBACK. The transaction ID is also specified with an appropriate value k.

As indicated above, the following control information is needed and must be supported by the LDAP server to realize transactions:

Transaction control (TxnControl):

OID: A unique LDAP object identifier.

Description: Control used on first and last requests of a request sequence that is to be considered as a transaction.

Criticality: Always critical.

Possible Values: Value is exactly one char 0 terminated string in UTF-8 encoding representing exactly one of the strings (words) NEW, COMMIT, and ROLLBACK. Case of these strings is insensitive.

Transaction ID (TxnId):

OID: A unique LDAP object identifier.

Description: Indicates the transaction ID k assigned to the transaction that the request is a part of.

Criticality: Always critical.

Possible Values: Value is exactly one char 0 terminated string in UTF-8 encoding representing a nonnegative, nonzero long int value (less than or equal to 2,147,483,647=2−1) in decimal format which is the transaction ID. (Only values formerly received from the LDAP server are allowed; all others are rejected.).

LDAP update requests are Modify, Add, Delete, and ModifyDN.

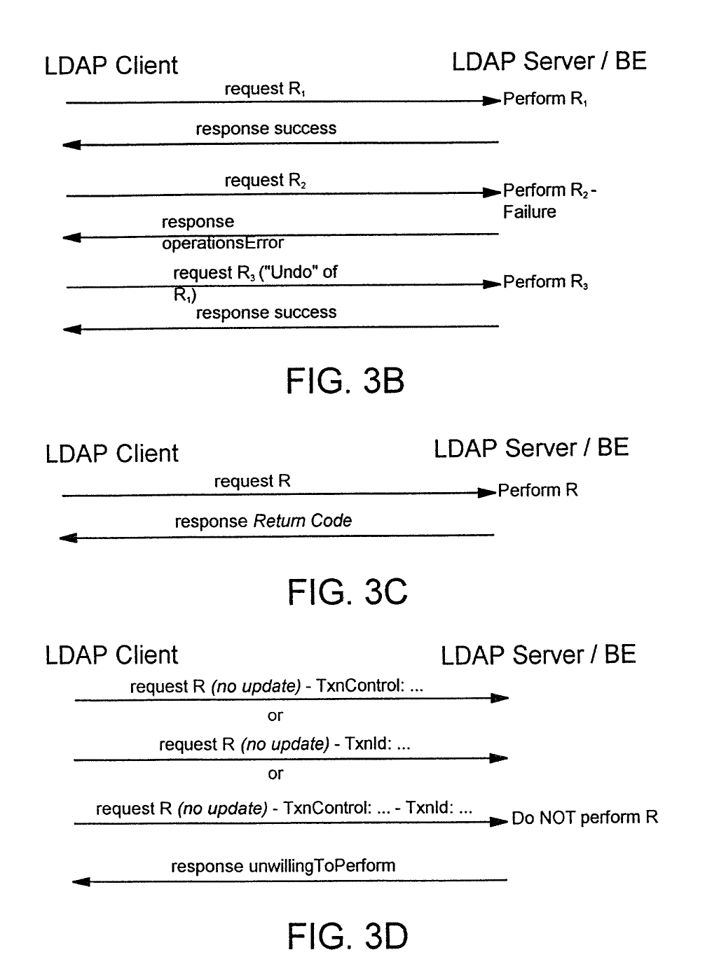

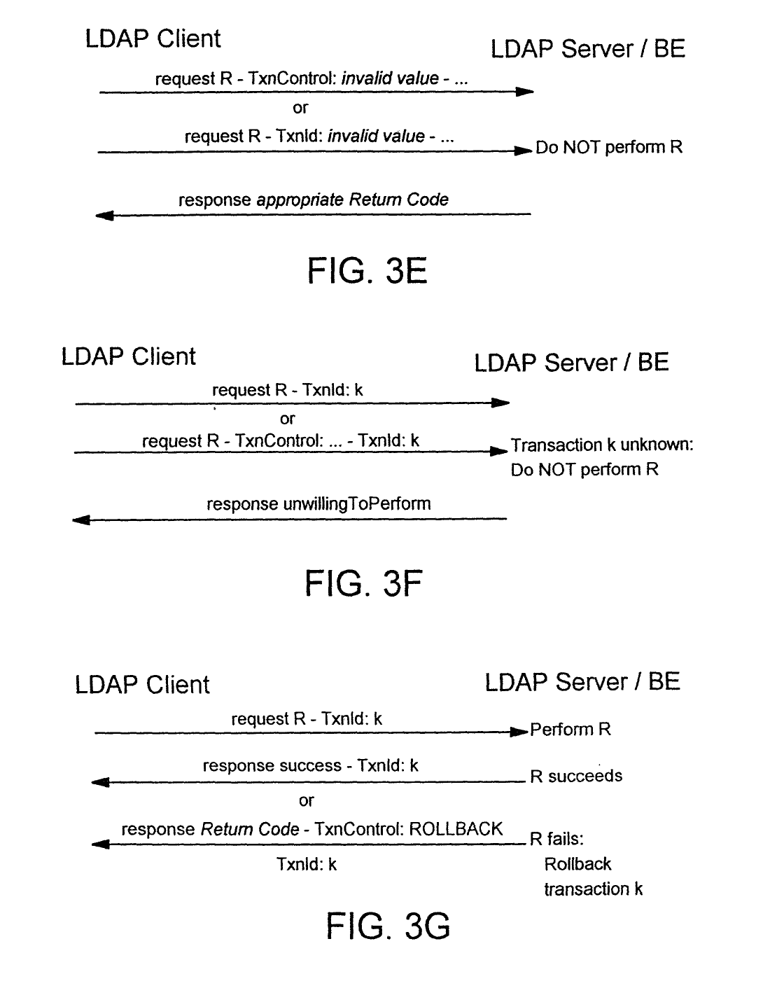

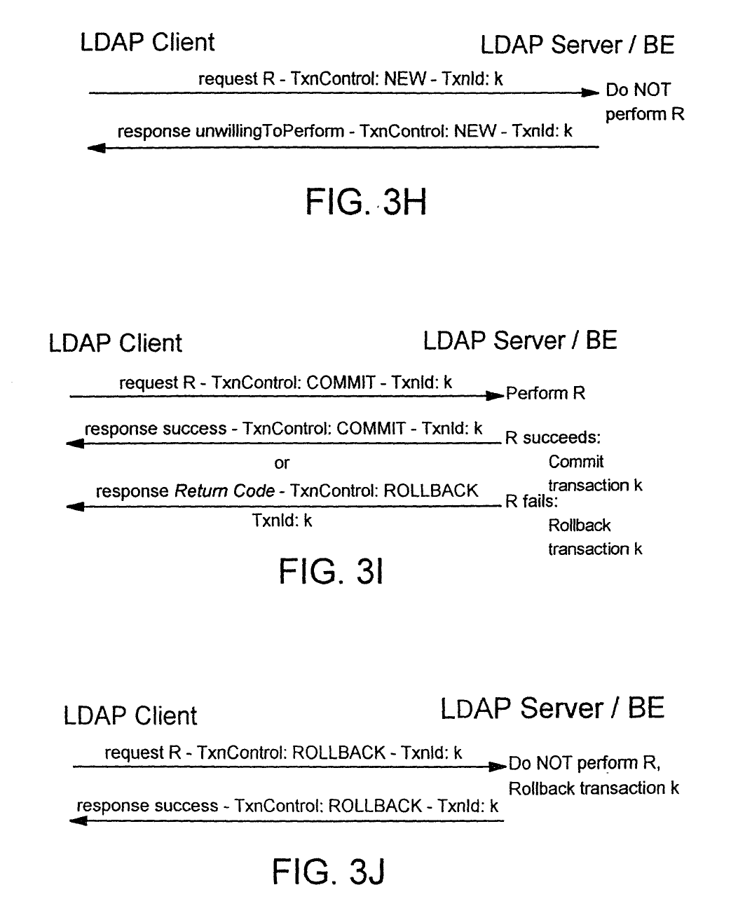

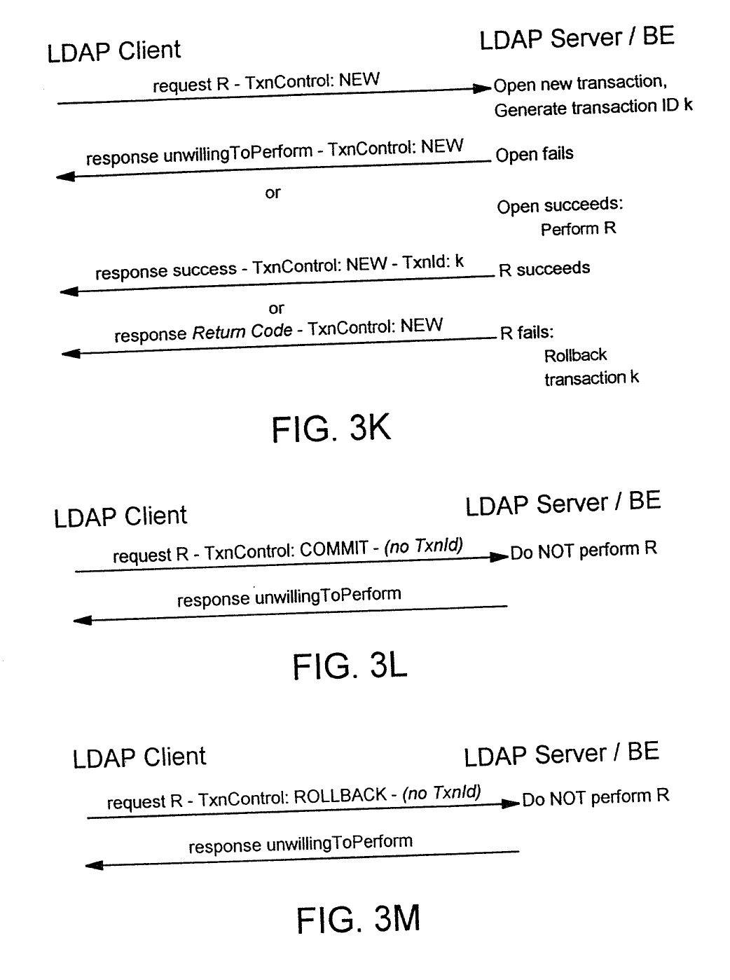

FIGS. 3A-3M show different response behavior of the LDAP server based on the information contained in the requests.

FIG. 3A is an example of the standard case in LDAP V3 in which no transaction support is available. All requests are performed in sequential order. The individual requests have no relationship from the LDAP server point of view.

Referring to FIG. 3B, if no transaction facilities are available from the LDAP server/backend, the LDAP server tracks whether an individual request belonging to a sequence of related requests fails. In the case of request failure, the LDAP client has to build the requests manually which restore the old data.

Referring to FIG. 3C, if a request R contains neither TxnControl nor TxnId, R is performed as a single atomic request. Neither of the controls TxnControl and TxnId is added to the response.

Referring to FIG. 3D, if a request R that is not an update request contains either TxnId or TxnControl or both, R is not performed and the response contains a result code “unwillingToPerform”. Neither of the controls TxnControl and TxnId is added to the response.

Referring to FIG. 3E, if a request R contains TxnControl with a syntactically invalid value, as specified in RFC 2251, R is not performed. Similarly, if a request R contains TxnId with a syntactically invalid value, as specified in RFC 2251, R is not performed.

Referring to FIG. 3F, if a request R contains TxnId with an ID k which does not denote an open transaction, R is not performed and the response contains the result code “unwillingToPerform”. Neither of the controls TxnControl and TxnId is added to the response.

Referring to FIG. 3G, if a request R contains TxnId with a valid ID k and does not contain TxnControl, R is performed. If R can be performed successfully, TxnId with the appropriate ID k is added to the response. TxnControl is not included in the response. If R fails, all of the effects caused by requests belonging to the transaction identified by ID k are rolled back, the transaction identified by the ID k is closed, and the response is extended with TxnId (value k) and TxnControl (value ROLLBACK).

Referring to FIG. 3H, if a request R contains TxnId with a valid ID k and TxnControl with the value NEW, R is performed. The transaction identified by k remains open. The response is extended with TxnId (value k) and TxnControl (value NEW).

Referring to FIG. 3I, if a request R contains TxnId with a valid ID k and TxnControl with the value COMMIT, R is performed. If R can be performed successfully, TxnId (value k) and TxnControl (value COMMIT) are added to the response and the transaction identified by k is closed (i.e. committed). If R fails, all of the effects caused by requests belonging to the transaction identified by k are closed, and the response is extended with TxnId (value k) and TxnControl (value ROLLBACK).

Referring to FIG. 3J, if a request R contains TxnId with a valid ID k and TxnControl with the value ROLLBACK, R is not performed. All of the effects caused by requests belonging to the transaction identified by k are rolled back, the transaction identified by k is closed, and the response is extended with TxnId (value k) and TxnControl (value ROLLBACK).

Referring to FIG. 3K, if a request does not contain TxnId and contains TxnControl with the value NEW, a new transaction with identifier k is opened. If this operation fails, R is not performed and the response contains the result code “unwillingToPerform”; the response is extended with TxnControl (value NEW), but no transaction ID is included. If a new transaction can be successfully opened, R is performed. If R can be performed successfully, TxnId (value k) and TxnControl (value NEW) are added to the response and the transaction identified by k remains open. If R fails, all of the effects caused by R are rolled back, the transaction identified by k is closed, and the response is extended with TxnControl (value NEW). The transaction ID is not included in the response.

Referring to FIG. 3L, if a request R does contain TxnId and contains TxnControl with the value COMMIT, R is not performed and the response contains the result code “unwillingToPerform”. Neither of the controls TxnControl and TxnId is added to the response.

Referring to FIG. 3M, if a request R does not contain TxnId and contains TxnControl with the value ROLLBACK, R is not performed and the response contains the result code “unwillingToPerform”. Neither of the controls TxnControl and TxnId is added to the response.

Summarizing, the present invention allows transactional LDAP clients to work with non-transactional LDAP servers if transactions are not used. If, in this case, transactions are used, the LDAP server will deny transactions although it does not know about transactions. This is a major advantage of our invention.

Non-transactional LDAP clients can work with transactional LDAP servers without problems.

Extended requests simply contain a unique object identifier (OID) and a (string) value. (In fact, they contain the same information as an LDAP V3 control.) Extended requests are standalone requests which do not refer to specific entries in the DIT managed by the LDAP server. LDAP V3 controls, on the other hand, are added to “normal” requests, like add, delete, or search, which always refer to entries or DIT subparts.

LDAP servers may delegate the management of certain DIT subparts to so called backends. This is, in fact, what the OS/390 Security Server LDAP Server does: The whole DIT is partitioned into subtrees which are managed by backends. The LDAP server simply chooses the appropriate backend for handling a request. In order to be able to do so, the incoming request must contain a reference to an entry or DIT subpart.

If an incoming request contains no reference to the DIT, the LDAP server cannot delegate the request to a backend since no backend is appropriate. This is the case for LDAP V3 extended requests. They can be only handled by the LDAP server itself and cannot be delegated without further rules. Such rules might be specified: Extended requests with OID x are handled by backend y. But these rules are very specific and not part of LDAP V3.

That is why the realization of transactions using controls is much easier than using extended requests. Appropriate “transaction controls” are simply added to requests and are routed to the appropriate backend, automatically. So, only the backend is responsible for supporting the controls and realizing transactional behavior. With this solution, the LDAP server does not need to know the OIDs of the controls and does not have to do anything to support transactions.

This is different with an extended request solution: At least, the LDAP server has to know the OIDs of the “transaction extended requests” and has to inform the appropriate backend(s). In the worst case, the LDAP server has to support transactions itself.

What is claimed is:

1. A method for realizing transactions with an existing protocol used by different system components communicating with each other, wherein each transaction contains update requests belonging together and each update request is generated by a first system component and transmitted to a second system component allowing access to a storage medium on which information to be updated is stored, said method being performed automatically and comprising the steps of:
(a) opening a transaction by adding a transaction control to an update request to create an extended update request supported by the protocol securing exchange of update requests between said system components;
(b) generating a transaction identifier for said transaction supported by said protocol;
(c) adding said transaction identifier to each update request belonging to said opened transaction; and
(d) automatically closing said transaction by using a transaction control supported by said protocol.

2. A method according to claim 1, wherein said first system component is installed on a client system and said second system component is installed on a server system.

3. A method according to claim 2, wherein said transaction identifier is generated by said server system.

4. A method according to claim 2, wherein said transaction identifier is generated by said client system.

5. A method according to claim 2, wherein said transaction identifier is sent from said server system to said client system.

6. A method according to claim 1, wherein step (a) is performed with a first update request of a sequence of update requests forming a transaction.

7. A method according to claim 1, wherein said update request is a delete, modify or add request.

8. A method according to claim 1, wherein said transaction control for opening a transaction according to step (a) has a value indicating a new transaction.

9. A method according to claim 1, wherein said step (d) is performed with a last update request of a sequence of update requests forming a transaction.

10. A method according to claim 1, wherein said transaction control for closing a transaction according to step (d) has a value indicating a commit or a rollback.

11. A method according to claim 1, wherein all extended update requests belonging to a transaction are stored to a queue and performed as a whole when an update request containing a transaction control having a value indicating a commit is received.

12. A method according to claim 1, wherein each individual extended update request belonging to a transaction is performed immediately after data to be updated has been stored on a nonvolatile storage medium.

13. A method according to claim 1, wherein said protocol is LDAP V3.

14. A method according to claim 13, wherein said transaction control and said transaction identifier each comprise a control name and a control value, wherein said name comprise a unique LDAP object identifier and said value comprises binary data.

15. A method according to claim 1, wherein said information to be updated is stored in a directory information tree.

16. A method according to claim 1, wherein an update request containing neither a transaction control nor a transaction identifier is performed as a single atomic request.

17. A method according to claim 1, wherein an update request with a transaction control with a syntactically invalid value is not performed.

18. A method according to claim 1, wherein all update requests identified by a transaction identifier are performed, a transaction control having a value indicating a commit and said transaction identifier are added to the response, and the transaction identified by said transaction identifier is closed if an update request containing a transaction control having a value indicating a commit and a valid transaction identifier corresponding to said transaction identifier is received by said server system.

19. A method according to claim 1, wherein all effects caused by said update requests belonging to the transaction identified by said transaction identifier are rolled back, said transaction is closed, and a response is extended with a transaction control having a value indicating a rollback and with said transaction identifier if said update request cannot be performed successfully.

20. A method according to claim 1, wherein a new transaction is opened when an update request does not contain a transaction identifier and contains a transaction control with a value indicating a new transaction.

21. A method according to claim 1 wherein all effects caused by said update requests are rolled back, the transaction identified by said transaction identifier is closed, and a response is extended with a transaction control having a value indicating a new transaction but not with said transaction identifier if the first request of a transaction cannot be performed successfully.

22. A computer program product containing parts of software code for executing the method in accordance with claim 1 when said software code is running on a digital computer.

23. A system for updating information comprising:
a client system containing a client program for adding transaction control information and a transaction identifier to update requests according to the claim 1; and
a server system containing a server program for generating a transaction identifier according to claim 1 and accessing or updating information; and
a data storage medium containing information to be accessed or updated.

24. A system according to claim 23 wherein said client program is an LDAP client program, said server program is an LDAP server program, and said information to be updated or accessed is stored in a directory information tree.

25. A system according to claim 24, further comprising:
a backend for managing a subtree of said directory information tree containing information to be updated; and
a component which is part of said server program for routing an update request to said backend managing said subtree of said directory information tree containing the information to be updated.

26. A system comprising:
a client data processing system; and
a client program installed on said system comprising at least a component for adding transaction control information and a transaction identifier to update requests according to claim 1.

27. A system comprising:
a server data processing system; and
a server program installed on said system comprising at least a component for generating a transaction identifier according to claim 1 and a component for accessing or updating data.
